(19) United States
(12) Patent Application Publication
(10) Pub. No.: US 2009/0124329 A1
(43) Pub. Date: May 14, 2009

(54) System and/or methods for interpreting and/or re-presenting content in a gaming environment

(76) Inventor: Angelo Palmisano, Crystal lake, IL (US)

Correspondence Address: NIXON & VANDERHYE, PC, 901 NORTH GLEBE ROAD, 11TH FLOOR, ARLINGTON, VA, 22203, US

(21) Appl. No.: 11/979,944

(22) Filed: Nov. 9, 2007

(51) Int. Cl. A63F 9/24; G06F 15/16; G06F 15/173

(52) U.S. Cl. 463/20; 709/201; 709/224

(57) ABSTRACT

Certain exemplary embodiments described herein relate to gaming machines and/or table games having programmed logic circuitry for interpreting existing content in the gaming environment and re-presenting it to a player via a new, though familiar, user interface, while also allowing further content to be displayed to the player. This advantageously enables the patron experience to be changed through a richer interface to the gaming environment, while also reducing the need to perform major replacement services by re-presenting existing, and integrating new, components and features.

### TECHNICAL FIELD

The exemplary embodiments described herein relate to gaming machines and/or table games used within a gaming environment and, more particularly, to gaming machines and/or table games having programmed logic circuitry (e.g., any suitable combination of hardware, software, firmware, and/or the like) for interpreting existing content in the gaming environment and re-presenting it to a player via a new, though familiar, user interface, while also allowing further content to be displayed to the player.

### BACKGROUND AND SUMMARY

For years, gaming machines (e.g., of the type typically found in casinos, on riverboats, and/or in other gambling establishments) have provided patrons or players with enjoyment and proprietors with revenue. Broadly speaking, they have evolved from simple, classic slot machines featuring mechanical arms that a player would pull, to more complicated video-based versions of slots, poker, and other games, with one or more buttons sometimes replacing the functions served by the mechanical arm. Further changes have included, for example, incorporating multiple displays to support advertising and/or sometimes even additional games.

As the desire for more engaging entertainment has increased yet further, some providers began configuring their gaming machines for use in a networked environment. This innovation, in turn, has enabled some providers to offer custom player tracking features for gaming establishments. Such player tracking features enable gaming establishments to track individual and/or group game play throughout the establishment, establish loyalty programs for patrons (e.g., based on amount wagered and/or won, time spent at the establishment, frequency of use, etc), etc.

Conventional player tracking systems enable such features by sometimes providing patrons with cards that uniquely identify them. Card readers are integrated into the gaming machines, and an LED display and/or vacuum fluorescent display (VFD) and associated keypad typically provide a user interface for the patron playing the game. The user interface may be used to, for example, enter a PIN to confirm that the patron is authorized to be using the card, make wagers, call for an attendant (e.g., for help or for drinks), etc.

Although such player tracking systems and end-machine displays and interfaces have represented an improvement to basic gaming operations, further improvements are still possible. For example, existing end-machine displays and interfaces tend to be old and limited in the amount, type, and/or quality of information that may be presented to the patron. Similar limitations exist with respect to the amount and/or type of other functionality that may be provided in connection with secondary services, such as, for example, hotel and/or concierge services, additional games, etc.

Thus, it will be appreciated that it would be desirable to upgrade existing player tracking systems and/or end-gaming devices.

Several gaming providers have sought to provide upgrades to the gaming experience, especially with respect to player tracking services. For example, Bally's iView, IGT's NextGen, and Aristocrat's Sentinel 3 provide enhanced gaming features. These products “up-sell” legacy systems and replace existing backend systems to provide a suite of new features for patrons. This typically requires replacement of gaming devices, backend databases, and/or the like. The approach of substantially replacing system components has met with varying levels of success. In part, this is because these solutions require abandonment of existing systems or components and replacement with newer systems or components, which often represents a fairly high initial investment. As such, there typically is a high startup cost, significant amount of waste, and potentially lengthy transition period.

Thus, it will be appreciated that there is a need in the art for overcoming one or more of these and/or other disadvantages, and/or for interpreting existing content in the gaming environment and re-presenting it to a player via a new, though familiar, user interface, while also allowing further content to be displayed to the player.

One aspect of certain exemplary embodiments involves maintaining a substantial part of the player tracking system and/or gaming device. In certain exemplary embodiments, only a small number of components on the gaming devices would need to be replaced, and new system components could simply be added. By way of example and without limitation, the LED display and/or the VFD, and/or the keypad may be replaced, whereas the gaming device, card acceptor, player tracking database, etc., may be maintained. Additional jackpot controllers, bonus systems, concierge modules, and/or the like simply may be added to the gaming network.

Another aspect of certain exemplary embodiments relates to interpreting signals from components in the gaming environment and re-presenting them as familiar but different forms for patrons, and also conveying input from the patrons to the appropriate components in the gaming environment in a usable format.

Still another aspect of certain exemplary embodiments relates to providing new services (e.g., television and/or media streams, bonus reward payouts, concierge services, etc.) for patron enjoyment.

Thus, certain exemplary embodiments provide techniques for changing the patron experience through a richer interface to the gaming environment, while reducing the need to perform major replacement services by re-presenting existing and integrating new features.

In certain exemplary embodiments, a gaming device for use in a networked gaming environment is provided. The networked gaming environment includes at least one backend database for providing content to the gaming device and/or for gathering information from the gaming device. The gaming device comprises at least one display. A user interface is configured to enable a user of the gaming device to select at least some of the content to be displayed on the gaming device. A content interpreter is configured to determine whether content to be displayed via the gaming device is to be displayed in either an original form or a modified form based at least in part on a predefined re-presentation rule, and also to modify the original form of the content to be displayed via the gaming device to the modified form in dependence on the determination. The content interpreter is further configured to enable communication between the user interface, the gaming device itself, and the at least one backend database by re-presenting user input received from the user interface, gaming device signals generated by the gaming device, and/or database signals generated by the at least one backend database in an appropriate format independent of signal source and destination.

In certain exemplary embodiments, a gaming device for use in a networked gaming environment including at least one backend database is provided. A user interface is configured to enable a user of the gaming device to provide user input to the gaming device. A content interpreter is configured to capture, interpret, and re-present signals for a plurality of sources, with the plurality of sources including at least the user interface, the at least one backend database, and the gaming device. The content interpreter is further configured to determine a signal source and a signal destination for captured signals. The content interpreter is further configured to re-present captured signals, in original or modified form, in dependence on the signal source and the signal destination so as to enable communication therebetween.

In certain exemplary embodiments, a content interpreter for use in a networked gaming environment is provided. The content interpreter is configured to enable a new gaming device, backend database, user interface, and/or network component to be implemented independent of existing gaming environment components. The content interpreter comprises programmed logic circuitry for capturing, interpreting, and re-presenting signals from a plurality of sources, with the plurality of sources including at least a user interface, at least one backend database, and a gaming device. The programmed logic circuitry is configured to determine a signal source and a signal destination for captured signals. The programmed logic circuitry is configured to interpret and re-present captured signals, in original or modified form, in dependence on the signal source and the signal destination so as to enable communication therebetween.

In certain exemplary embodiments, a method of providing new and re-presenting existing content in a networked gaming environment is provided. At least one central system is provided to the gaming network. At least one gaming device is configured for use with the gaming network. Signals sent between a signal source and a signal destination are monitored. When the signals from the signal source are not interpretable by the signal destination, the signals from the signal source are captured and re-presented so as to enable communication at least between the signal source and the signal destination. At least one re-presentation rule is defined, with each said re-presentation rule being indicative of when original content to be displayed via a gaming device is to be modified. Original content to be displayed via the gaming device is monitored. When the original content to be displayed via the gaming device matches a re-presentation rule, modified content different from the original content is created in accordance with a predefined format different from an original format of the original content.

In certain exemplary embodiments, in a networked gaming environment including existing gaming components, there is provided a method of enabling a new gaming component to be implemented independent of the existing gaming components. A new gaming component is provided. Signals from a plurality of sources are captured, interpreted, and re-presented, with the plurality of sources including one or more of a new of existing user interface, at least one backend database, and a gaming device. When a signal is captured, a signal source and a signal destination for the captured signal are determined. When the captured signal is interpreted, the captured signal is re-presented, in original or modified form, in dependence on the signal source and the signal destination so as to enable communication therebetween.

These exemplary features, aspects, and advantages may be combined in various combinations and ways to achieve yet further embodiments.

### BRIEF DESCRIPTION OF THE DRAWINGS

These and other features, aspects, and advantages will be better and more completely understood by reference to the following detailed description of exemplary illustrative embodiments in conjunction with the drawings, of which:

FIG. 1 is a current gaming machine for use with a current gaming network of the type typically used in casinos;

FIG. 2 shows a plurality of gaming machines and associated peripherals being located on a casino floor and being connected in a networked environment;

FIG. 3 is an improved gaming machine in accordance with an exemplary embodiment;

FIG. 4 shows a plurality of improved gaming machines and associated peripherals located on a casino floor and being connected in a network environment in accordance with an exemplary embodiment;

FIG. 5 is a simplified block diagram of a content interpreter in accordance with an exemplary embodiment;

FIG. 6 shows an example connection between an existing player tracking hardware device and a content interpreter, in accordance with an exemplary embodiment;

FIG. 7 is an illustrative logged-out display including re-presented content in accordance with an exemplary embodiment;

FIG. 8 is an illustrative login display in accordance with an exemplary embodiment;

FIG. 9 is an illustrative logged-out display including re-presented content and a re-presented user interface, in accordance with an exemplary embodiment;

FIG. 10 is another illustrative login display in accordance with an exemplary embodiment;

FIG. 11 is an illustrative logged-in display in a random rewards environment showing re-presented content in accordance with an exemplary embodiment;

FIG. 12 is another illustrative logged-in display in a random rewards environment showing re-presented content and a re-presented user interface in accordance with an exemplary embodiment;

FIG. 13a is an illustrative flowchart showing a process for providing new and re-presenting existing content, in accordance with an exemplary embodiment;

FIG. 13b is an illustrative flowchart showing a process for providing new and re-presenting existing content in a networked gaming environment, in accordance with an exemplary embodiment;

FIG. 13c is an illustrative flowchart showing a process for enabling a new gaming component to be implemented independent of the existing gaming components, in accordance with an exemplary embodiment;

FIG. 14 shows a plurality of improved table games being located on a casino floor and being connected in an improved networked environment in accordance with an exemplary embodiment;

FIG. 15 is a partial schematic view of a casino floor including connections to improved gaming machines and improved table games in accordance with an exemplary embodiment; and

FIG. 16 is an illustrative multi-property layout of improved gaming machines and improved table games in accordance with an exemplary embodiment.

### DETAILED DESCRIPTION

The exemplary embodiments described herein relate to gaming machines and/or table games used within a gaming environment and, more particularly, to gaming machines and/or table games having programmed logic circuitry (e.g., any suitable combination of hardware, software, firmware, and/or the like) for interpreting existing content in the gaming environment and re-presenting it to a player via a new, though familiar, user interface, while also allowing further content to be displayed to the player. Advantageously, a substantial part of the player tracking system and/or gaming device may be maintained, while only a small number of components on the gaming devices would need to be replaced and new system components simply may be added. By way of example and without limitation, the LED display and/or the VFD, and/or the keypad may be replaced, whereas the gaming device, card acceptor, player tracking database, etc., may be maintained. Additional jackpot controllers, bonus systems, concierge modules, and/or the like simply may be added to the gaming network.

These and/or other features may be accomplished by providing programmed logic circuitry for interpreting signals from components in the gaming environment and re-presenting them as familiar but different forms for patrons, conveying input from the patrons to the appropriate components in the gaming environment in a usable format, and/or providing new services (e.g., television and/or media streams, bonus reward payouts, concierge services, etc.) for patron enjoyment. Thus, certain exemplary embodiments advantageously provide techniques for changing the patron experience through a richer interface to the gaming environment, while reducing the need to perform major replacement services by re-presenting existing and integrating new features.

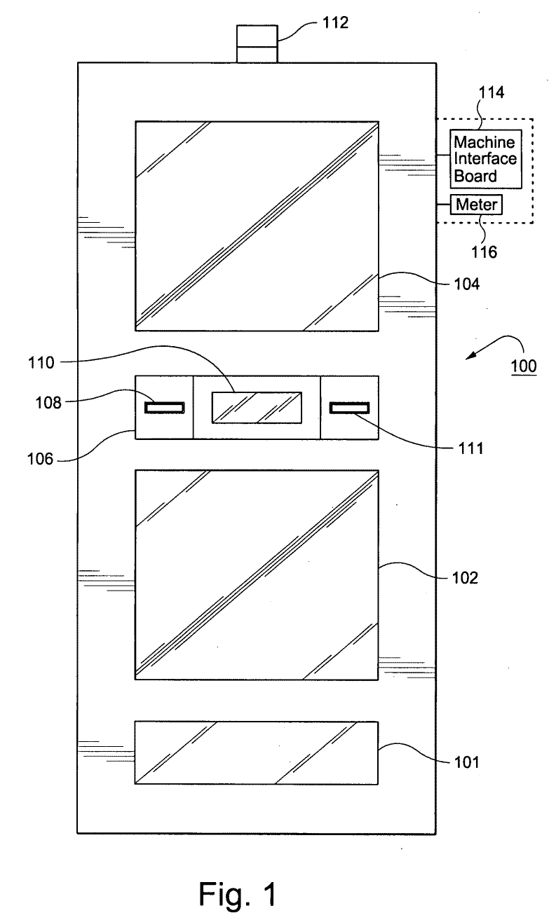

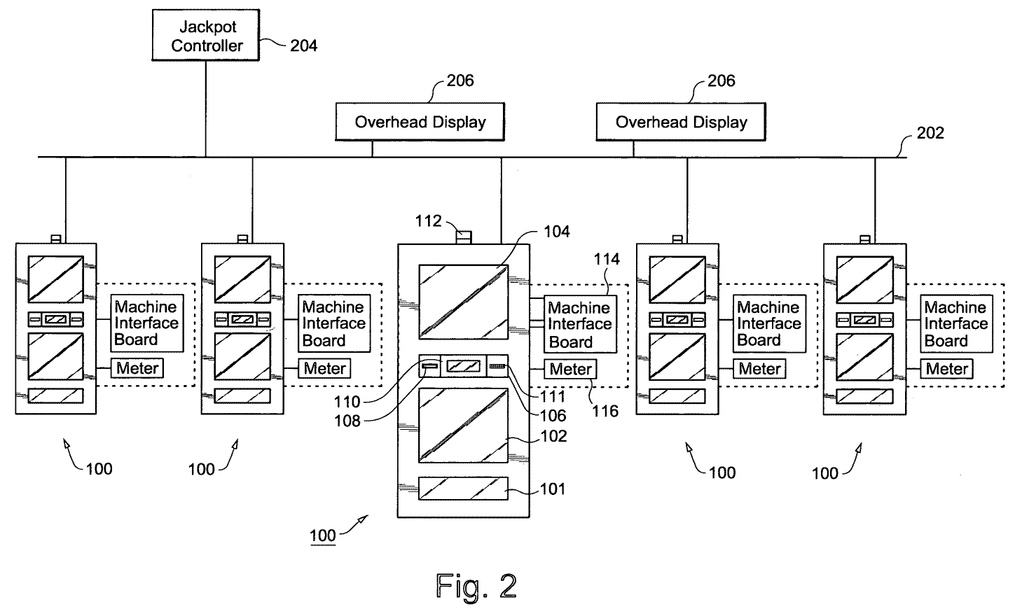

Referring now more particularly to the drawings, FIG. 1 is a current gaming machine 100 for use with a current gaming network of the type typically used in casinos, and FIG. 2 shows a plurality of gaming machines 100 and associated peripherals being located on a casino floor and being connected in a networked environment. For aesthetic purposes, belly glass 101 often is provided on gaming machines. Each gaming machine includes a first display area 102, generally referred to as a game screen. The game screen 102 traditionally has been where most of the “action” happens. For example, the game screen 102 may simulate the rolling of the reels on a slot machine and thus indicate whether the player has won any money. A second display area 104, generally referred to as a top box, also is provided. The top box 104 may display additional information for the player, such as, for example, advertising, generally entertaining animations, bonus game opportunities, etc.

The game screen 102 and/or the top box 104 may be touch screen monitors and thus accept input directly. Such input may pertain to, for example, the number of credits to bet, the way in which a bet may be made, whether to initiate a bet, whether to cash out, etc. In other cases, a separate control panel (not shown) may be provided to enable the same and/or similar functionality.

The gaming machine 100 also is provided with a player tracking module (PTM) area 106. The PTM area 106 includes a payment acceptor (e.g., a card reader, a coin and/or dollar acceptor, etc.) 108 to accept payment (e.g., cash, an encoded card storing credits or linked to a database with credit information, or the like) from the player. A small display screen (or PTM) 110 is located in the PTM area 106 and enables the player to access certain other more individualized services. For example, the PTM 110 may enable the player to call an attendant to order drinks. In such a case, the PTM 110 may cause the candle 112 (e.g., one or more differently colored lights) of the gaming machine 100 to become lit to signal to casino personnel that the player is requesting some form of service. The PTM 110 typically is operated using control panel 111.

The PTM 110 may have a computer-readable storage medium (not shown) associated therewith. The computer-readable storage medium typically is a small flash drive, hard drive, or other suitable memory location. Information may be distributed to the PTM 110 and at least temporarily stored on the computer-readable storage medium. In this way, it is possible to provide some media offerings to the gaming machine 100 for display by the PTM 110. More particularly, the computer-readable storage medium is used as a buffer for the media offerings that ultimately may be displayed by the PTM 110.

The game screen 102 and the top box 104, and the respective associated circuitry, typically are provided by a single company. The PTM 110 often is provided by another vendor. Sometimes, the PTM 110 will be integrated into the gaming machine 100. However, it is often the case that the gaming machine 100 will be retrofitted with a PTM 110. As such, the hardware and software systems for the game screen 102 and the top box 104 typically are independent of the hardware and software systems for the PTM 110.

This separation often makes integration between the various components cumbersome. Thus, to accommodate these features related to the PTM area 106, gaming machines are equipped with special purpose hardware to facilitate this and/or similar arrangements. It will be appreciated that the player management tracking and information management features provided typically exist outside of the normal base game(s) environment, which deal directly with game play rather than ancillary services, patron interaction, feedback, and the like.

It will be appreciated that although the gaming machines 100 shown in FIG. 2 all appear the same, the present invention is not so limited. A wide variety of gaming machines may be provided, as may table games, roulette tables, etc. Variations to each may include changes in terms of configuration, style, type, functionality, payouts, etc.

In many cases, an RS-485 connection is utilized. The connection often is to a machine interface board 114 located within each gaming machine. In essence, the machine interface board 114 translates between the gaming machine 100 and the network 202 so that the network 202 may communicate with the gaming devices 100.

As alluded to above, a plurality of gaming machines 100 may be located on a casino floor and be connected in a networked environment, e.g., via network 202. To this end, a plurality of central systems (not shown) are connected to the networked environment to collect and/or distribute data, as necessary. Each gaming machine 100 may be connected to one or more of the central systems via a network link. Such network links typically are proprietary and are based on unicast, broadcast, multi-drop, and/or other suitable network protocols. Although proprietary protocols often are implemented, the typical effect is that data is transmitted to/from the central systems over a broadcast channel or to one or more targeted groups (e.g., a bank of gaming machines in a row, in a particular area of the gaming floor, etc.) over connections.

There are at least three separate systems or modules comprising the central systems. A first system, management and accounting subsystem, provides management and accounting functions, also sometimes called auditing functions. Typically, these functions gather and/or report coin-in and coin-out operations, door openings (e.g., when a gaming machine is serviced), service cycles in general, ticket replacements, and the like. This activity generally is linked to the game being played on the gaming machine and/or the gaming machine itself.

A second system, player tracking subsystem, provides player tracking functions. More specifically, such systems link players on the gaming floor to particular activities undertaken by the players on the gaming floor. The information typically tracked for each player includes, for example, the session of game play (e.g., date, time, location, type of machine, type of game, etc.) as well as the individual's profile (e.g., name, address, and/or other identifying information such as hair color). The player tracking subsystem also may interface with the PTM 110 of a particular gaming machine 100.

A third system, bonusing subsystem, provides enhancements which may or may not be related to the base game. Such enhancements may relate to bonusing, progressive games, mystery, secondary games, random rewards (e.g., as disclosed in U.S. Pat. No. 6,626,758), etc. This system typically interfaces with the PTM 110.

Other systems may be included in the central systems. For example, other modules may be provided for detecting cash-in, cash-out, and/or data mining purposes. Data mining may be used, for example, in connection with marketing activities, accounting and/or auditing activities, etc.

Reports may be generated by the central systems, for example, to report on earnings, operational efficiencies, repairs, etc. Such reports also may be the result of the above-described data mining operations.

An in-machine meter 116 may be provided to the gaming machines 100 to cooperate with the central systems (e.g., to provide information regarding game plays, amounts of wagers, payoffs, etc.).

In addition to the gaming machines 100 existing in the network, one or more overhead displays 206 may be connected to the network 118. The overhead displays 206 may receive data from the central systems indicating, for example, the jackpot amount(s) (e.g., current, daily, monthly, etc.), payouts (e.g., current, daily, monthly, etc.), winners, etc.

A jackpot controller 204 also is connected to the network 202. A single jackpot controller may be assigned to a bank of gaming machines 100. Typically, a jackpot controller is configured to accept a single bank of up to 124 gaming machines. The jackpot controller 204 may be responsible for calculating jackpots, changing the turnover on every hit and/or on every play, returning the winning amounts, etc. The jackpot controller 204 may be a progressive jackpot controller or it may be a non-progressive jackpot controller. Alternatively, multiple jackpot controllers 204 may be used within a single bank or among multiple banks. For example, separate jackpot controllers 204 may be respectively responsible for progressive and non-progressive jackpots. In still other alternate arrangements, multiple instances running on one or more jackpot controllers 204 may be dedicated to various banks of gaming machines, progressive and/or non-progressive jackpots, etc. In still other alternative arrangements, jackpot controllers may be installed in each machine individually, so that the need for a network connection is reduced (e.g., sometimes even eliminated) and so that base games can be played on gaming machines in a more “stand-alone” arrangement.

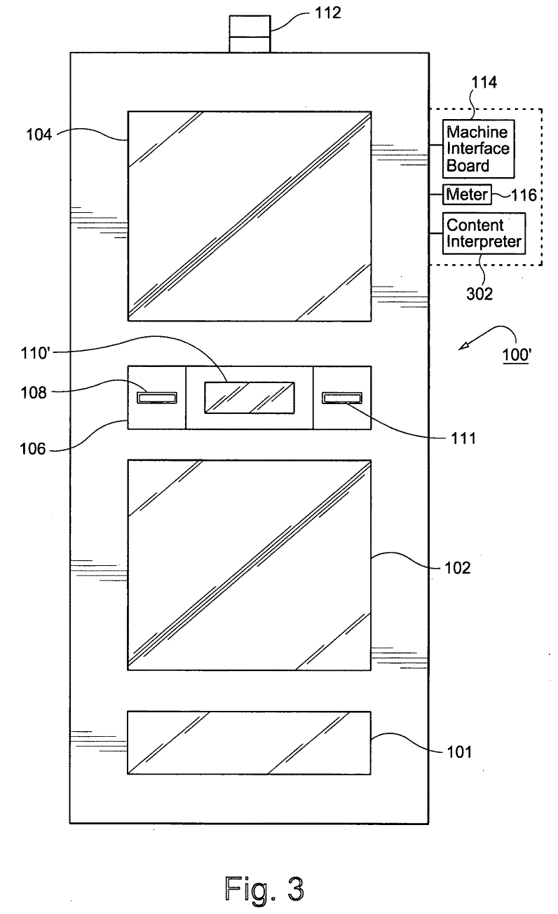

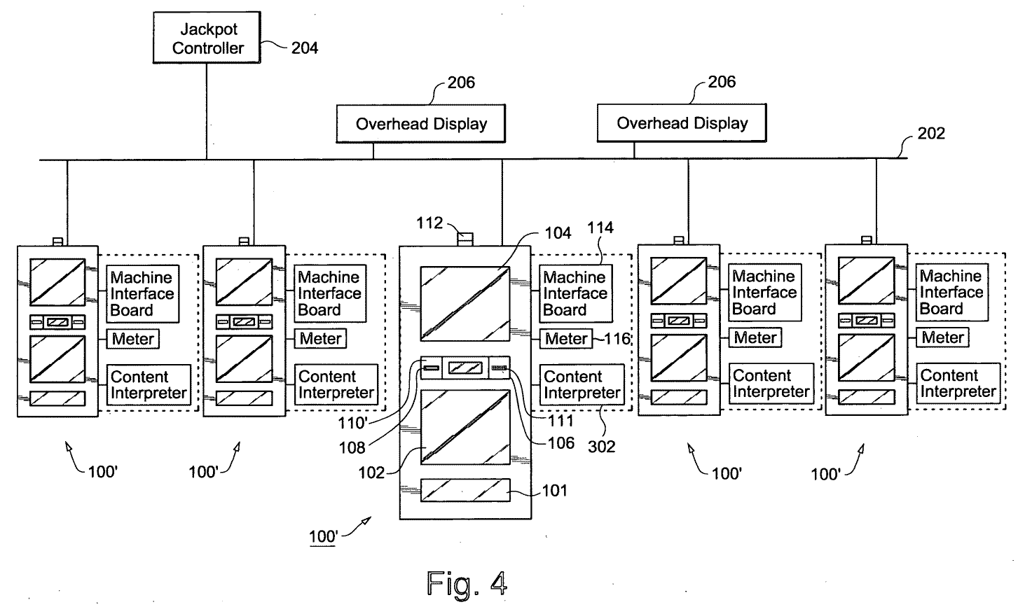

FIGS. 3 and 4 are similar to FIGS. 1 and 2. However, the gaming machines 100′ of FIGS. 3 and 4 each include programmed logic circuitry (e.g., any suitable combination of hardware, software, firmware, and/or the like) for interpreting existing content in the gaming environment and re-presenting it to a player via a new, though familiar, user interface, while also allowing further content to be displayed to the player. For convenience, such programmed logic circuitry is referred to as content interpreter 302. The gaming machine 100′ also may include an improved PTM 110′. The improved PTM 110′ may be configured to accept input directly from the patron (e.g., via a touch screen interface) and/or in connection with the now-optional control panel 111. The improved PTM 110′ may replace the older LED or VFD technology present in current gaming machines. In its place, a larger display (e.g., an LCD display may be provided).

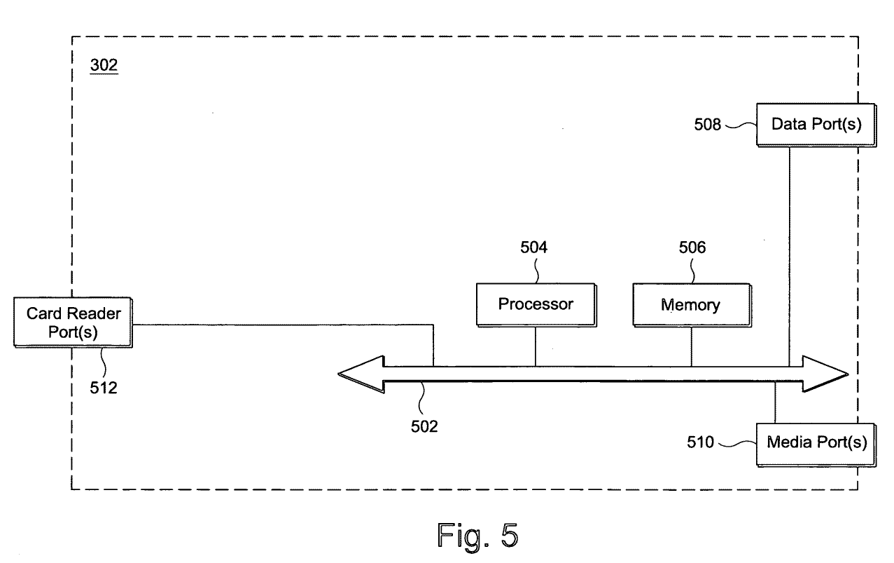

A simplified block diagram of a content interpreter 302 in accordance with an exemplary embodiment is provided in FIG. 5. It will be appreciated that the content interpreter 302 may be able to present, interpret, and/or re-present data and/or media. Thus, there is a bus 502 for relaying computer-readable signals between, for example, a processor 504, a memory 506 (which may be a disk drive device, a flash drive, an SD drive, or any suitable computer-readable storage medium), and/or one or more ports. With respect to the ports, one or more data ports 508 and media ports 510 are provided to the content interpreter 302. For example, the data ports 508 may send and receive data from the gaming device itself, to one or more of the central systems (e.g., the accounting system, the bonus system, etc.), and/or the like. One or more media ports 510 may send and receive data from a dedicated media server, to one or more displays on the gaming machine 100′ (e.g., the PTM 110′, the main screen 102, the top box 104, and/or the like), etc.

Media may be in the form of, for example, a video feed. The video feed, in turn, may be streamed to the gaming machine 100′ and played substantially in real-time. The video feed may include, for example, television, movies, sporting events, shows, custom programming, custom animations (e.g., to indicate a win, loss, large jackpot being hit by the patron using the gaming machine 100′ or another patron using a different gaming machine, etc.), and/or the like. To enable substantially real-time streaming, the video feeds optionally may be compressed. Also, a slight delay may be introduced, e.g., by using a store-forward technology in connection with a buffer (e.g., via memory 506).

Signals designated for and/or generated by the gaming machine will be received by the content interpreter 302. The processor 504 provided to the content interpreter 302 will determine how the signals should be processed. For example, if the signals correspond to the patron changing a channel, the processor 504 will communicate with the media server over the appropriate media port 510 to request a different channel. As another example, when a coin-out event is generated (e.g., when the patron hits a paytable win triggering the coin-out event requiring a credit to be issued to the patron's account), the signal will be received over the appropriate data port 508. The processor 504 may inform the appropriate central system of the win, e.g., for player tracking and/or account auditing purposes. Similarly, the processor 504 also may inform a media server of the win. In connection with this and/or other events, the media server also may determine that a media clip should be played by the gaming machine 100′, and a signal may be sent back to the gaming machine over an appropriate media port 510, and the processor 504 may cause this media clip to be played on an appropriate display of the gaming machine 100′. In still another example, the content interpreter 302 may detect a patron request for a concierge service. The processor 504 may interpret an ordering signal generated by the gaming machine (e.g., by user input to the PTM 110′, for example), relay this information over an appropriate data port 508, and/or relay a confirmation message and/or provide a wait time indication to the user from an appropriate concierge server.

It will be appreciated that the foregoing signals are provided by way of example and without limitation. Other signals may be captured, interpreted, processed, generated, and/or re-presented by the content interpreter 302. It also will be appreciated that a single captured signal may generate multiple signals in response (e.g., a patron inserting additional funds may require a credit to an account, a update to a player tracking system, an animation from a media server, etc.).

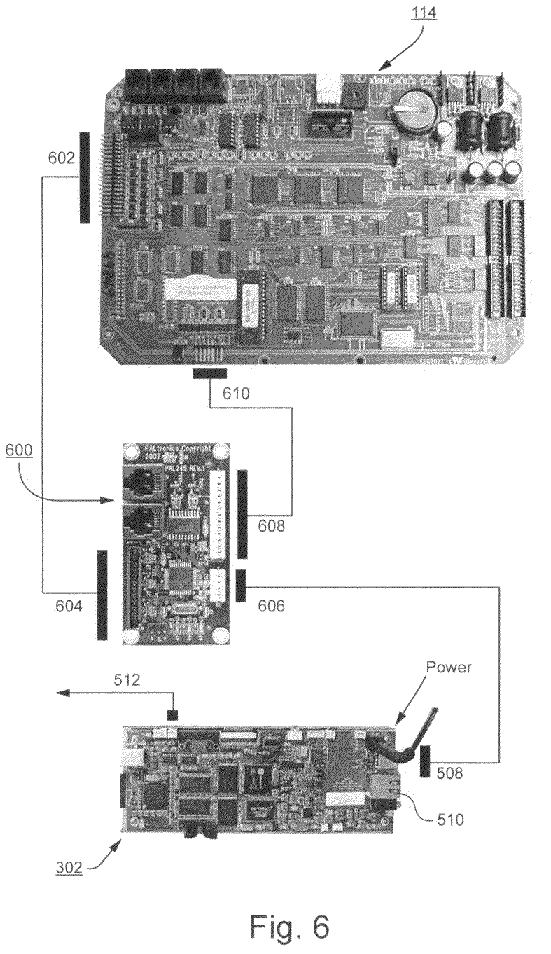

FIG. 6 shows an example connection between an existing player tracking hardware device and a content interpreter 302, in accordance with an exemplary embodiment. In particular, FIG. 6 shows an ACSC Slot Machine Interface Board (SMIB) available from Bally operably connected to a content interpreter 302 through a machine interface card (MIC) 600. The MIC 600 is optional, but it may be included in certain exemplary embodiments to enable, for example, bonus rewards to be distributed to the patron. Signals may be sent from a first port 602 of the SMIB 114 to a second port 604 of the MIC 600. Signals may be sent from a first port of the MIC 600 to a second port 610 of the SMIB 114. With respect to the content interpreter 302, signals may be sent back and forth to the SMIB 114 by passing from a data port 508 provided to the content interpreter 302 and through the MIC 600 through a third port 606 of the MIC 600. This connection may be bidirectional and may be any suitable connection (e.g., a serial link, a USB link, an Ethernet link, etc.). Media signals may be received from a media server, for example, via a media port 510 on the content interpreter 302. These signals may be relayed to the SMIB 114 through the MIC 600 as described above. The content interpreter 302 may require its own power supply (e.g., a +5V DC power supply). A traditional keypad 111 may be removed in case the gaming machine 100′ becomes too crowded with the addition of the content interpreter 302 and/or the MIC 600.

The following schematics are for an improved PTM 110′ with a content interpreter 302 mounted behind it and are provided by way of example and without limitation:
Illustrative Unit dimensions: 2⅞″ high×7 15/16″ W×1 13/16″ D
Illustrative Weight: 13.5 oz.
Illustrative Screen size: 7″ diagonal (2¼″ H×6″ W)
Illustrative Pixel format: 640×240
Illustrative Interface: 18-bit digital (6 bits/color)
Illustrative Operating temperature range: −20° C. to 60° C.
Illustrative Connection method: four screws (one at each corner) connect mounting bracket(s) to the gaming machine
Illustrative Operating system: Microsoft Embedded CE
Illustrative Memory: SD memory card

The following example components may be used in connection with certain exemplary embodiments:
Illustrative LCD Display: Hitachi TX16D11VM2CCA-2 (6.2″)
Illustrative Inverter: Microsemi LXM1618-05-2x
First illustrative power supply: CUI Inc. EPS050400U-P5P-KH
Second illustrative power supply: Powertron Electronics Corp. PA1030-050DUB
Illustrative single board computer: Boundary Devices Neon Board

Of course, it will be appreciated that the foregoing schematics components are provided by way of example and without limitation. Indeed, other components may be used in connection with other exemplary embodiments.

From FIGS. 5-6 and the descriptions thereof, it will be appreciated that certain exemplary embodiments provide a content interpreter for use in a networked gaming environment. The content interpreter is configured to enable a new gaming device, backend database, user interface, and/or network component to be implemented independent of existing gaming environment components. The content interpreter comprises programmed logic circuitry for capturing, interpreting, and re-presenting signals from a plurality of sources, with the plurality of sources including at least a user interface, at least one backend database, and a gaming device. The programmed logic circuitry is configured to determine a signal source and a signal destination for captured signals. The programmed logic circuitry is configured to interpret and re-present captured signals, in original or modified form, in dependence on the signal source and the signal destination so as to enable communication therebetween.

The signal source and the signal destination each may be one of a user interface, a gaming device, and at least one backend database. The new network component may be one or more of a media server, a food/drink ordering module, and a personal concierge service module. One of the existing gaming environment components may be, for example, a player tracking database. A module, as used herein, may be any suitable combination of programmed logic circuitry (e.g., hardware, software, firmware, and/or the like).

The content interpreter may be included in a gaming device, or it may be a network-level component. The content interpreter is configured to enable communication between a plurality of different backend databases and a plurality of different gaming devices independent of gaming device and/or backend database provider. Also, the content interpreter may be configured to enable a new backend database, user interface, and/or network component to be implemented independent of existing gaming environment components and/or communications protocols associated therewith. The new network service may be, for example, one or more of a media server, a food/drink ordering module, and a personal concierge service module.

Thus, in certain other exemplary embodiments, a gaming device for use in a networked gaming environment is provided. The networked gaming environment includes at least one backend database for providing content to the gaming device and/or for gathering information from the gaming device. The gaming device comprises at least one display. A user interface is configured to enable a user of the gaming device to select at least some of the content to be displayed on the gaming device. A content interpreter is configured to determine whether content to be displayed via the gaming device is to be displayed in either an original form or a modified form based at least in part on a predefined re-presentation rule, and also to modify the original form of the content to be displayed via the gaming device to the modified form in dependence on the determination. The content interpreter is further configured to enable communication between the user interface, the gaming device itself, and the at least one backend database by re-presenting user input received from the user interface, gaming device signals generated by the gaming device, and/or database signals generated by the at least one backend database in an appropriate format independent of signal source and destination.

In certain exemplary embodiments, then, a plurality of re-presentation rules may be predefined, with at least some of the re-presentation rules being based on signal source, signal destination, and/or content type. By way of example and without limitation, the content to be displayed on the gaming device selectable via the user interface includes media content, food/drink services, and personal concierge services.

Similarly, in certain exemplary embodiments, a gaming device for use in a networked gaming environment including at least one backend database is provided. A user interface is configured to enable a user of the gaming device to provide user input to the gaming device. A content interpreter is configured to capture, interpret, and re-present signals for a plurality of sources, with the plurality of sources including at least the user interface, the at least one backend database, and the gaming device. The content interpreter is further configured to determine a signal source and a signal destination for captured signals. The content interpreter is further configured to re-present captured signals, in original or modified form, in dependence on the signal source and the signal destination so as to enable communication therebetween.

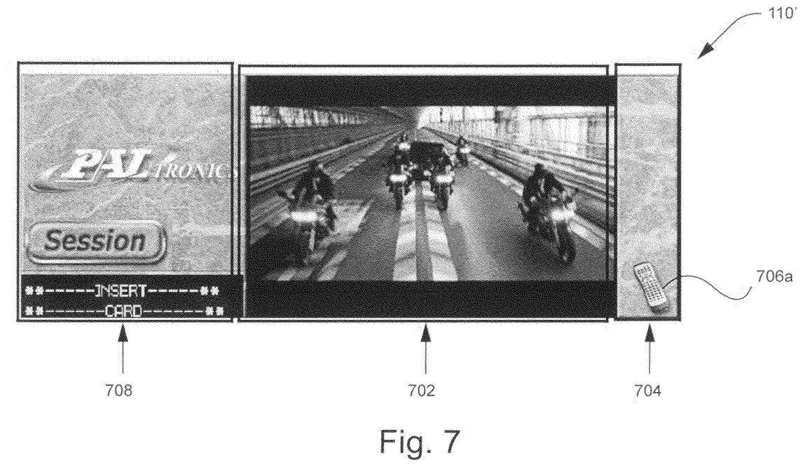

FIGS. 7-12 show a number of illustrative displays. Such displays may be generated by the content interpreter 302. Any suitable display on the gaming machine 100′ may present such illustrative displays to the patron. For example, the main screen 102, the top box 104, the improved PTM 110′, and/or any other suitable display may present such illustrative displays to the patron. Additionally, or in the alternative, such illustrative displays may be provided on one or more floating layers. Floating layers are described in, for example, co-pending and commonly-assigned application Ser. Nos. 11/889,970 and 11/889,971, the entire content of each of which are hereby incorporated herein by reference.

By way of example and without limitation, each of FIGS. 7-12 is shown as being displayed on a PTM 110′. Also by way of example and without limitation, the illustrative displays are shown as having several main components, including a media window 702 (e.g., for displaying programming according to a player-selected channel, special events, etc.), a menu bar 704 including one or more icons 706 corresponding to various features made available to the patron through the illustrative displays, and a player communication window 708 for displaying messages to the player (e.g., for prompting the player to insert a card, notifying the player of individual and/or group gaming statistics, displaying reward amounts, and/or the like), etc.

FIG. 7 is an illustrative logged-out display including re-presented content in accordance with an exemplary embodiment. In FIG. 7, the media window 702 is shown as displaying a movie in accordance with a channel selected by the player. The menu bar 704 includes a remote control icon 706a for changing channels. The player communication window 708 indicates that no card has been inserted and prompts the player to insert a suitable card.

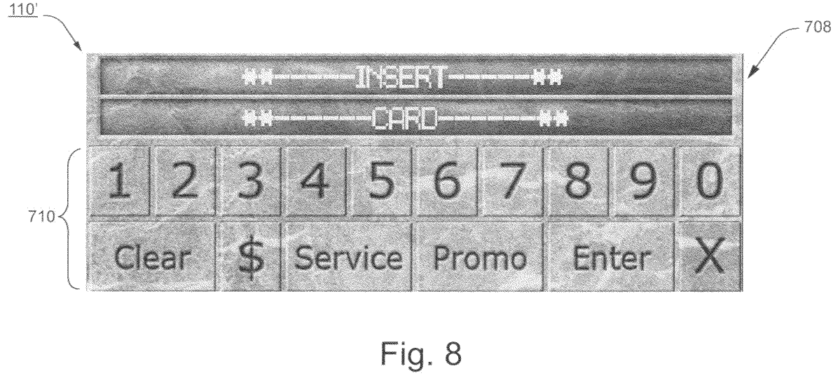

FIG. 8 is an illustrative login display in accordance with an exemplary embodiment. The display of FIG. 8 provides a control panel 710. The control panel 710 enables the player to, for example, enter a PIN (e.g., associated with the player card), seek service (e.g., order food and/or drinks, call an attendant, report a problem with the gaming machine, etc.), provide credits to the gaming machine, etc. The player communication window 708 indicates that no card has been inserted and prompts the player to insert a suitable card.

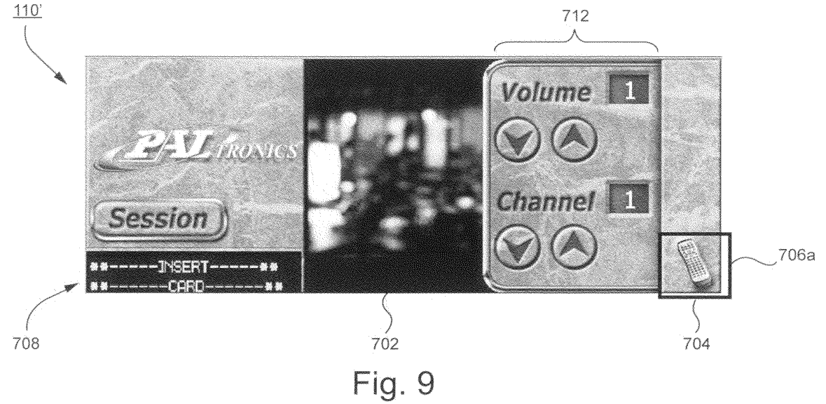

FIG. 9 is an illustrative logged-out display including re-presented content and a re-presented user interface, in accordance with an exemplary embodiment. Again, the player communication window 708 indicates that no card has been inserted and prompts the player to insert a suitable card. The media window 702, which is displaying a movie, is at least partially obscured by a remote control panel 712, activated when a player selects the remote control icon 706a from the menu bar 704. The remote control panel 712 enables a player to adjust, for example, the volume of the content, the channel being watched, etc.

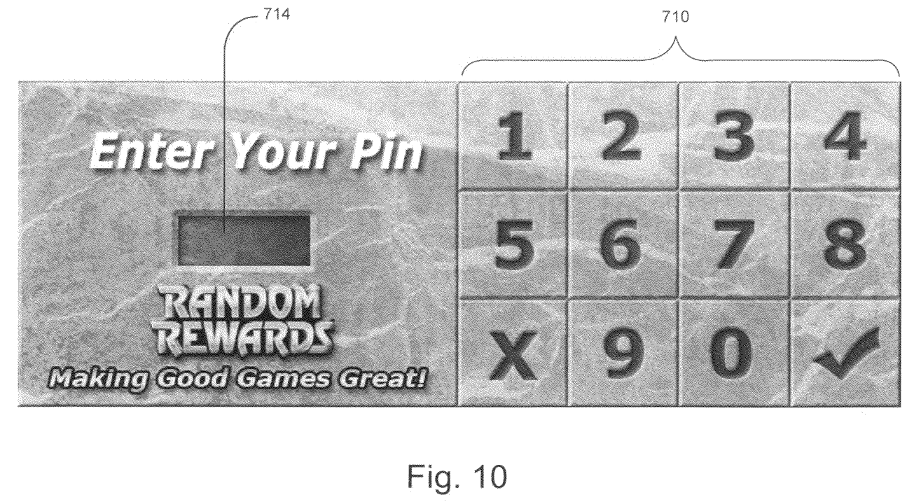

FIG. 10 is another illustrative login display in accordance with an exemplary embodiment. In FIG. 10, the control panel 710 enables the player to enter a PIN associated with the player card. The PIN and/or representations of the data input by the player (e.g., a star, asterisk, “x,” or the like) may be displayed in feedback area 714.

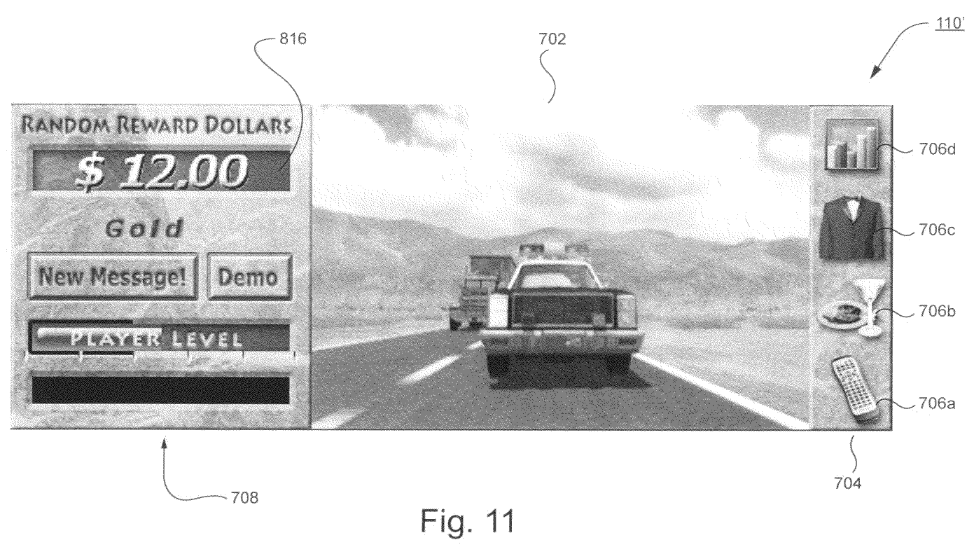

FIG. 11 is an illustrative logged-in display in a random rewards environment showing re-presented content in accordance with an exemplary embodiment. In FIG. 11, the media window 702 is shown as displaying a movie in accordance with a channel selected by the player. The menu bar 704 includes a remote control icon 706a for changing channels, a food/drink icon 706b for ordering food and/or drink (e.g., for room service, restaurant pre-orders, bar service, delivery to the gaming machine, etc.), a concierge icon 706c (e.g., for making hotel reservations, for ordering valet service, ordering taxis, providing information about local attractions, and/or the like), and statistics icon 706d enables the player to view gaming statistics (e.g., about the particular player and/or machine, about the gaming operation as a whole, etc., which information may be based at least in part on data stored by a management and accounting central server). The player communication window 708 indicates that the player is a “gold level” player, and that the player is about 50% of the way to becoming a “platinum level” player (e.g., through game play amounts and/or times, winnings, losses, hotel stays, etc.). The random rewards amount 816 displays a random reward that is winnable by the player on each wager in accordance with a random rewards scenario. Of course, it will be appreciated that other information may be displayed, e.g., in connection with a particular bonus game implemented.

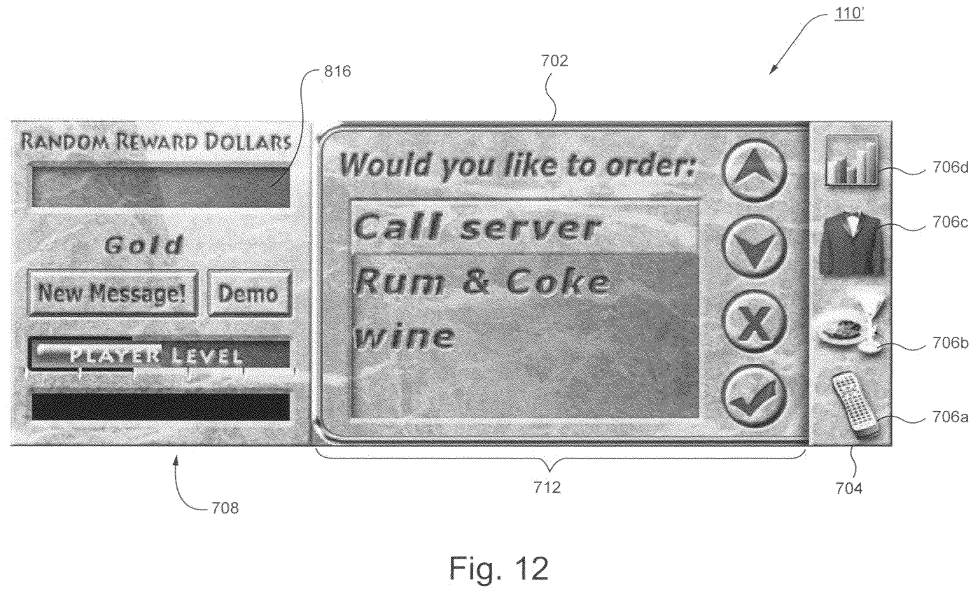

FIG. 12 is another illustrative logged-in display in a random rewards environment showing re-presented content and a re-presented user interface in accordance with an exemplary embodiment. FIG. 12 is like FIG. 11. However, in addition to the display of FIG. 11, the media window 702 of FIG. 12 is obscured by the server control panel 712, activated when the player selects the food/drink icon 706b from the menu bar 704.

It will be appreciated that the foregoing illustrative displays are provided by way of example and without limitation. For example, other display configurations may be provided, e.g., to correspond with the same, similar, and/or other services or features offered via the gaming machine. The particular services or features offered via the gaming machine may depend, for example, on the backend databases in communication with the gaming machine, the presence of media servers on the gaming network, the particular signals generatable by the gaming machine itself, and/or the like.

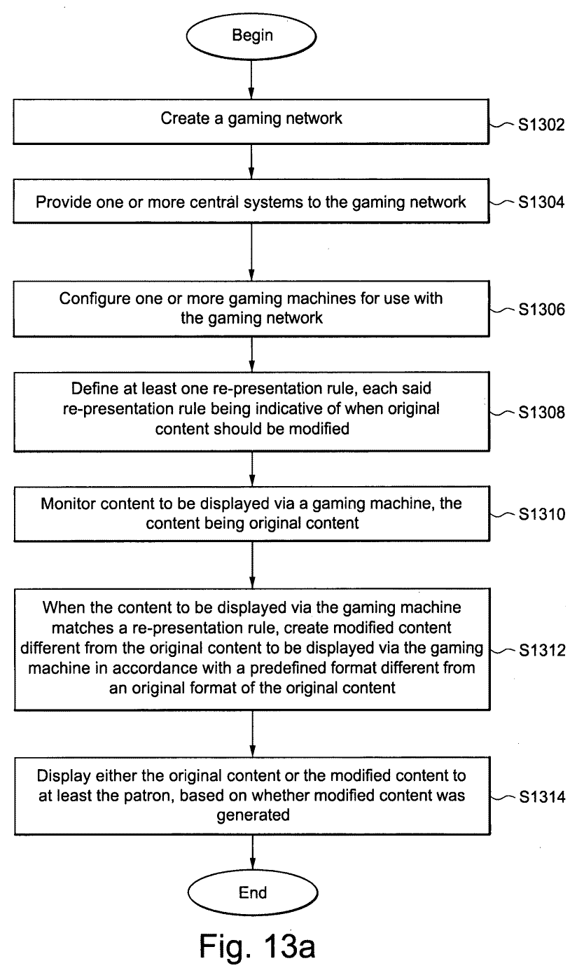

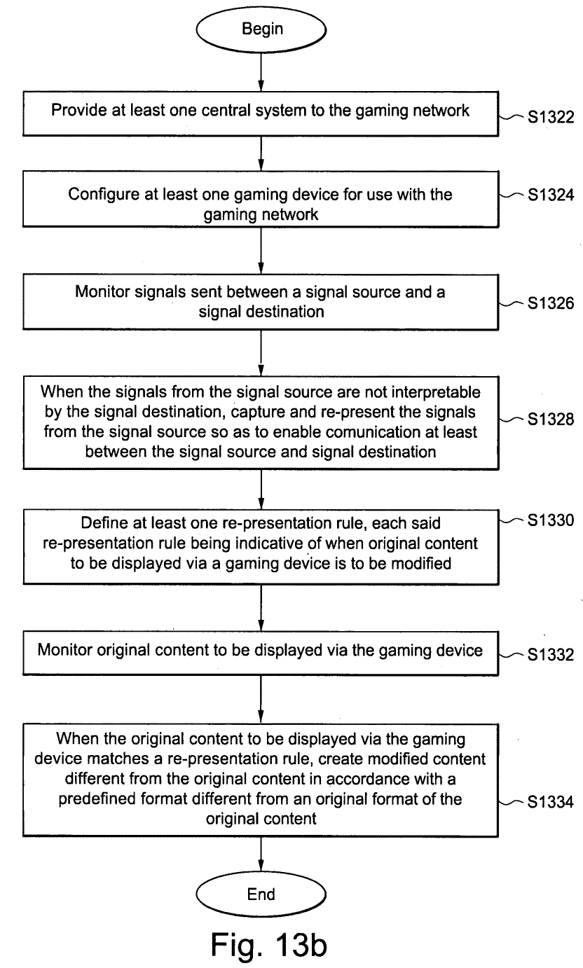

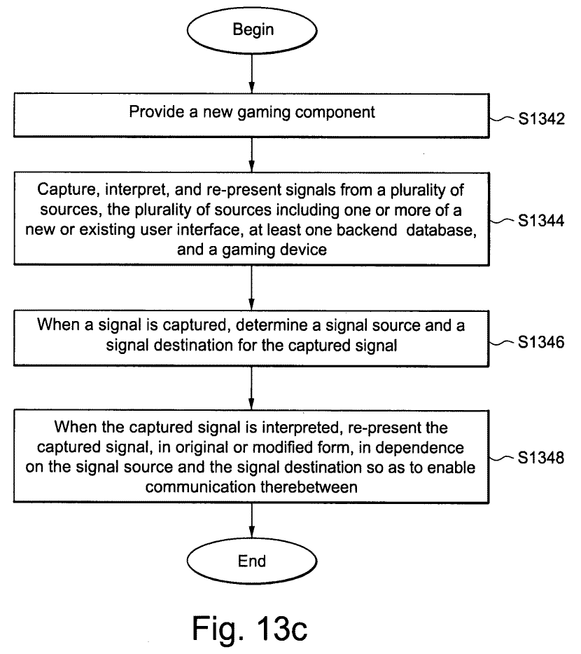

FIG. 13a is an illustrative flowchart showing a process for providing new and re-presenting existing content, in accordance with an exemplary embodiment. In step S1302, a gaming network is created. In step S1304, one or more central systems are provided to the gaming network. One or more gaming machines are configured for use with the gaming network in step S1306. At least one re-presentation rule is defined in step S1308, with each said re-presentation rule being indicative of when original content should be modified. Any number of suitable re-presentation rules may be defined. For example, re-presentation rules may be based on the source of the signals (e.g., signals from a particular backend system may be flagged for re-presentation and/or from the gaming machine itself, whereas signals from a different backend system may not), based on the destination of the signals (e.g., all signals to the PTM 110′ may be flagged for re-presentation, whereas signals designated for the main screen and/or the top box may not), the type of content (e.g., basic gaming data pertaining to patron wagering may be flagged for re-presentation, whereas media streams may not), etc.

In step S1310, content to be displayed via a gaming machine is monitored, with such content being original content. In step S1312, when the content to be displayed via the gaming machine matches a re-presentation rule, modified content different from the original content to be displayed via the gaming machine is created in accordance with a predefined format different from an original format of the original content. It will be appreciated that this process may involve the capturing, interpretation (e.g., decoding and/or encoding), and/or re-presentation of signals in accordance with a signal specific to the gaming machine and/or the components driving and/or used in connection with the gaming machine (e.g., the machine interface board, the backend systems, etc.).

The format may include where (e.g., on which screen, in relation to particular fields, etc.), when (e.g., on wins, on every wager, at certain times, at certain intervals, etc.), and/or how the information should be displayed; the particular arrangement(s) of the display(s); and/or the like. Either the original content or the modified content is displayed at least to the patron, based on whether modified content was generated, in step S1314. Optionally, the content may also be displayed to one or more other gaming devices and/or peripherals connected to the gaming network.

Similar to FIG. 13a, FIG. 13b is an illustrative flowchart showing a process for providing new and re-presenting existing content in a networked gaming environment, in accordance with an exemplary embodiment. In FIG. 13b, at least one central system is provided to the gaming network in step S1322. At least one gaming device is configured for use with the gaming network in step S1324. Signals sent between a signal source and a signal destination are monitored in step S1326. When the signals from the signal source are not interpretable by the signal destination, the signals from the signal source are captured and re-presented so as to enable communication at least between the signal source and the signal destination in step S1328. At least one re-presentation rule is defined in step S1330, with each said re-presentation rule being indicative of when original content to be displayed via a gaming device is to be modified. Original content to be displayed via the gaming device is monitored in step S1332. When the original content to be displayed via the gaming device matches a re-presentation rule, modified content different from the original content is created in accordance with a predefined format different from an original format of the original content in step S1334.

Either the original content or the modified content may be displayed to at least a patron using the gaming device, based on whether modified content was generated. Also, the capturing and re-presenting may enable communication between a plurality of different backend databases and a plurality of different gaming devices, independent of gaming device and/or backend database provider.

Similar to FIGS. 13a and 13b, FIG. 13c is an illustrative flowchart showing a process for enabling a new gaming component to be implemented independent of the existing gaming components, in accordance with an exemplary embodiment. In FIG. 13c, a new gaming component is provided in step S1342. Signals from a plurality of sources are captured, interpreted, and re-presented, with the plurality of sources including one or more of a new of existing user interface, at least one backend database, and a gaming device in step S1344. When a signal is captured, a signal source and a signal destination for the captured signal are determined in step S1346. When the captured signal is interpreted, the captured signal is re-presented, in original or modified form, in dependence on the signal source and the signal destination so as to enable communication therebetween in step S1348.

The new gaming component and at least one of the existing gaming components may be supplied by different providers such that signals sent therebetween would be unusable absent said capturing, interpreting, and re-presenting of said signals.

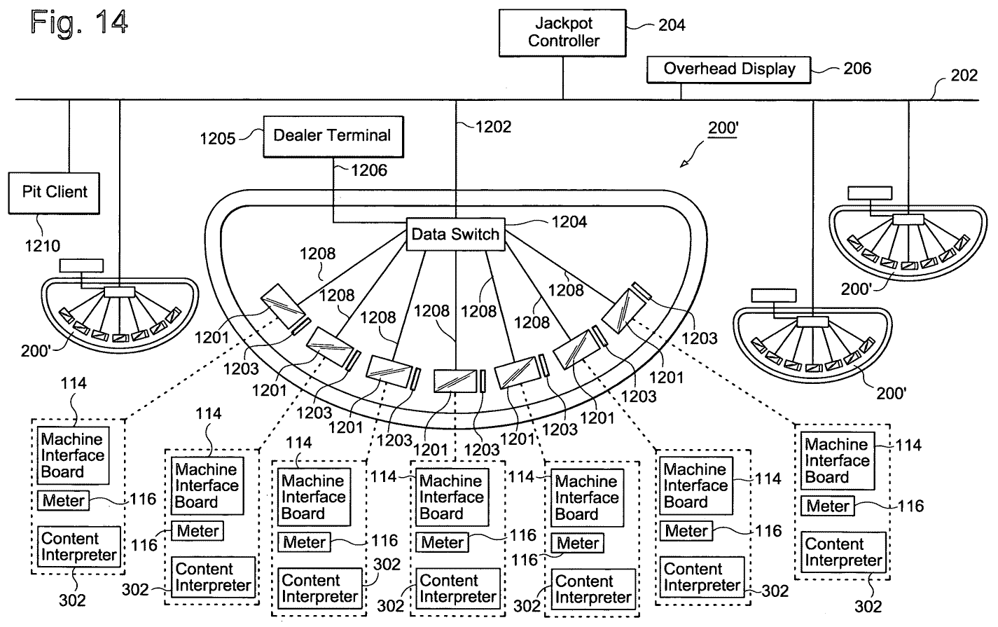

It will be appreciated that similar techniques may be applied to table games. For example, FIG. 14 shows a plurality of improved table games 200′ being located on a casino floor and being connected in an improved networked environment in accordance with an exemplary embodiment. In FIG. 14, each improved table 200′ has a number of player positions. More particularly, seven player positions are shown, as this is the customary number of player positions at blackjack tables, for example. Of course, the invention is not limited to a particular number of player positions or to any particular table game.

Each player position includes a display 1201 and a payment acceptor and/or card reader 1203 (similar to the payment acceptor 108 described above). The player may have the ability to place side wagers and/or a main wager via the interface offered by the display 1201. Also, each display 1201 also may show the illustrative displays of FIGS. 7-12. In general, each display 1201 enables the player at that player position, for example, to allocate credits among the BGCM and the RRCM as described above. Each player position also includes a machine interface board 114, an in-table meter 116, and display interpreter 302, similar to the components described above with relation to FIG. 3. These components are not shown at every table 200′ for the sake of readability of FIG. 12.

There also is a dealer terminal 1205 provided to each table. The dealer terminal 1205 includes a player representation and a keypad. The dealer may use the dealer terminal to make player credits/debits, retrieve the status of any player (e.g., amount of credits, whether the player is a preferred patron, etc.), and the like. For example, the dealer may designate a player in the player representation and indicate, via the keypad, whether to credit/debit the player's account, what the player's hand included, etc.

Data may be logged (e.g., to one or more databases of the central servers) during and/or after the play of each player.

A connection 1202 is provided to each table 200′ from the network 202 so as to connect each respective table 200′ to, for example, the central systems (not shown) and the jackpot controller 204 via a data switch 1204. Via connection 1206, the data switch connects the dealer terminal 1205 to the network 202. Similarly, via connection 1208, the data switch 1204 connects each of the player positions to the network 202.

In certain exemplary embodiments, each table 200′ will have its own associated data switch 1204. In such exemplary instances, the network 202 may be kept more “flat” and thus network latencies may be decreased. However, in certain other exemplary embodiments, the player positions and the dealer terminal may be directly addressable across the network 202.

A pit client 1210 also sits on the network 202. A pit, or area of table games within a casino, typically comprises 2-12 such tables. There may be multiple pits within a single casino. One or two pit bosses typically are assigned to a pit. In place of or in addition to pit bosses, the pit client 1210, via its connection to the central systems 202 and to the tables individually, may provide substantially real-time player ratings. These player ratings may be actual, rather than merely estimated, ratings. In addition to actual and substantially real-time ratings, actual substantially real-time player and table accountings may be gathered. Moreover, promotional and/or contributional bonusing may be provided based on an individual's identity, an individual player's rating, on a particular table's action, on the action within a pit, on a property-wide basis, according to a multi-property basis, etc. Similarly, random rewards may be distributed on the same and/or other categories in place of, or in addition to, the player opt-in techniques described above in relation to the gaming machine exemplary embodiments.

Although a single jackpot controller 204 is shown on the network, the present invention is not so limited. For example, a jackpot controller 204 or an instance of a jackpot controller 204 may be provided to each pit.

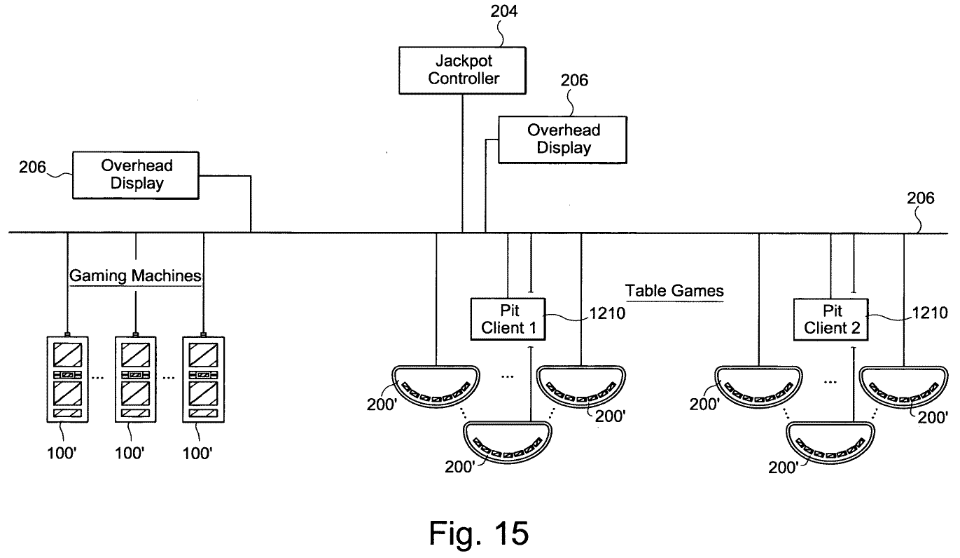

FIG. 15 is a partial schematic view of a casino floor including connections to improved gaming machines 100′ and improved table games 200′ in accordance with an exemplary embodiment. The improved gaming machines 100′ and improved table games 200′ are, of course, connected to the network 202. The table games 200′ may be divided into one or more pits, as is conventional.

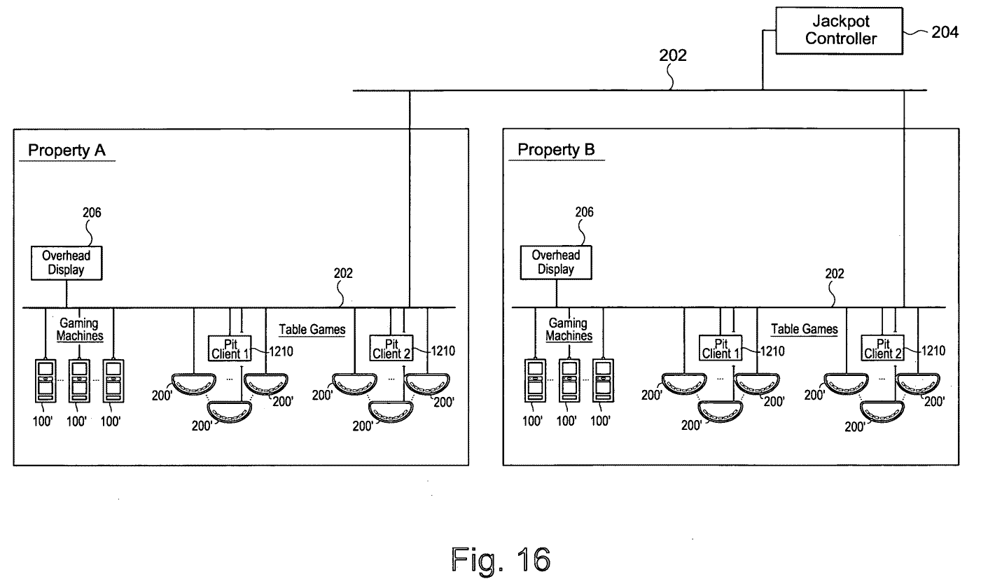

FIG. 16 is an illustrative multi-property layout of improved gaming machines and improved table games in accordance with an exemplary embodiment. In certain exemplary embodiments, some or all of the above-described features may be provided across multiple properties. Thus, for example, random rewards scenarios and/or pools may be defined across multiple properties. Thus, one or more jackpot controllers 204 may be provided for multiple properties to share.

The content interpreter is shown as being connected to individual gaming devices in certain exemplary embodiments. However, the present invention is not so limited. For example, a single content interpreter could be provided at or near, for example, a particular backend system, a bank of grouping of gaming devices, an entire location in a multi-property gaming environment, etc., where it is desirable to provide the interpretation and/or re-presentation techniques of certain exemplary embodiments in connection therewith.

Although certain exemplary embodiments have been described as relating to gaming machines and table games in casinos, it will be appreciated that the present invention is not so limited. For example, the exemplary embodiments described herein may be used in connection with casinos, riverboats, restaurants, hotels, etc. Also, it will be appreciated that similar to the application of the player content interpretation and/or re-presentation techniques described in relation to gaming machines and/or table games, certain exemplary embodiments may be applied to other gaming devices including, for example, roulette tables, craps tables, etc.

The techniques may be used in connection with any existing gaming devices and/or, backend systems. For example, the content interpreter of certain exemplary embodiments may be used in connection with Bally ACSC and/or SDS, IGT Acres, Aristocrat Oasis, and/or the like. Thus, certain exemplary embodiments provide techniques for changing the patron experience through a richer interface to the gaming environment, while reducing the need to perform major replacement services by re-presenting existing and integrating new features.

Also, the exemplary features, aspects, and advantages described herein may be combined in yet further ways to achieve further embodiments.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A gaming device for use in a networked gaming environment, the networked gaming environment including at least one backend database for providing content to the gaming device and/or for gathering information from the gaming device, said gaming device comprising:
at least one display;
a user interface configured to enable a user of the gaming device to select at least some of the content to be displayed on the gaming device;
a content interpreter configured to determine whether content to be displayed via the gaming device is to be displayed in either an original form or a modified form based at least in part on a predefined re-presentation rule, and to modify the original form of the content to be displayed via the gaming device to the modified form in dependence on the determination,
wherein the content interpreter is further configured to enable communication between the user interface, the gaming device itself, and the at least one backend database by re-presenting user input received from the user interface, gaming device signals generated by the gaming device, and/or database signals generated by the at least one backend database in an appropriate format independent of signal source and destination.

2. The gaming device of claim 1, wherein a plurality of re-presentation rules are predefined, at least some of the re-presentation rules being based on signal source, signal destination, and/or content type.

3. The gaming device of claim 1, further comprising a touch screen display, the user interface being accessible to the user via the touch screen display.

4. The gaming device of claim 1, wherein the content to be displayed on the gaming device selectable via the user interface includes media content, food/drink services, and personal concierge services.

5. The gaming device of claim 1, wherein the content interpreter is configured to enable communication between a plurality of different backend databases and a plurality of different gaming devices independent of gaming device and/or backend database provider.

6. The gaming device of claim 1, wherein the gaming device is a gaming machine or a table game.

7. A gaming device for use in a networked gaming environment including at least one backend database, said gaming device comprising:
a user interface configured to enable a user of the gaming device to provide user input to the gaming device; and
a content interpreter configured to capture, interpret, and re-present signals for a plurality of sources, the plurality of sources including at least the user interface, the at least one backend database, and the gaming device,
wherein the content interpreter is further configured to determine a signal source and a signal destination for captured signals, and
wherein the content interpreter is further configured to re-present captured signals, in original or modified form, in dependence on the signal source and the signal destination so as to enable communication therebetween.

8. The gaming device of claim 7, wherein the signal source and the signal destination each are one of: the user interface, the gaming device, and at least one backend database.

9. The gaming device of claim 7, wherein the content interpreter is configured to enable a new backend database, user interface, and/or network component to be implemented independent of existing gaming environment components and/or communications protocols associated therewith.

10. The gaming device of claim 9, wherein the new network service is one or more of a media server, a food/drink ordering module, and a personal concierge service module.

11. The gaming device of claim 7, wherein the gaming device is a gaming machine or a table game.

12. A content interpreter for use in a networked gaming environment, the content interpreter being configured to enable a new gaming device, backend database, user interface, and/or network component to be implemented independent of existing gaming environment components, the content interpreter comprising:
programmed logic circuitry for capturing, interpreting, and re-presenting signals from a plurality of sources, the plurality of sources including at least a user interface, at least one backend database, and a gaming device,
wherein the programmed logic circuitry is configured to determine a signal source and a signal destination for captured signals, and
wherein the programmed logic circuitry is configured to interpret and re-present captured signals, in original or modified form, in dependence on the signal source and the signal destination so as to enable communication therebetween.

13. The content interpreter of claim 12, wherein the signal source and the signal destination each are one of: a user interface, a gaming device, and at least one backend database.

14. The content interpreter of claim 12, wherein the content interpreter is included in a gaming device.

15. The content interpreter of claim 12, wherein the content interpreter is a network-level component.

16. The content interpreter of claim 12, wherein the new network component is one or more of a media server, a food/drink ordering module, and a personal concierge service module.

17. The content interpreter of claim 12, wherein one of the existing gaming environment components is a player tracking database.

18. A method of providing new and re-presenting existing content in a networked gaming environment, the method comprising:
providing at least one central system to the gaming network;
configuring at least one gaming device for use with the gaming network;
monitoring signals sent between a signal source and a signal destination;
when the signals from the signal source are not interpretable by the signal destination, capturing and re-presenting the signals from the signal source so as to enable communication at least between the signal source and the signal destination;
defining at least one re-presentation rule, each said re-presentation rule being indicative of when original content to be displayed via a gaming device is to be modified;
monitoring original content to be displayed via the gaming device; and
when the original content to be displayed via the gaming device matches a re-presentation rule, creating modified content different from the original content in accordance with a predefined format different from an original format of the original content.

19. The method of claim 18, further comprising displaying either the original content or the modified content to at least a patron using the gaming device, based on whether modified content was generated.

20. The method of claim 18, wherein a plurality of re-presentation rules are predefined, at least some of the re-presentation rules being based on signal source, signal destination, and/or content type.

21. The method of claim 18, wherein the capturing and re-presenting enables communication between a plurality of different backend databases and a plurality of different gaming devices, independent of gaming device and/or backend database provider.

22. In a networked gaming environment including existing gaming components, a method of enabling a new gaming component to be implemented independent of the existing gaming components, the method comprising:
providing a new gaming component;
capturing, interpreting, and re-presenting signals from a plurality of sources, the plurality of sources including one or more of a new of existing user interface, at least one backend database, and a gaming device;
when a signal is captured, determining a signal source and a signal destination for the captured signal; and
when the captured signal is interpreted, re-presenting the captured signal, in original or modified form, in dependence on the signal source and the signal destination so as to enable communication therebetween.

23. The method of claim 22, wherein the new gaming component is one or more of a media server, a food/drink ordering module, and a personal concierge service module.

24. The method of claim 22, wherein at least one of the existing gaming components is a player tracking database.

25. The method of claim 22, wherein the new gaming component and at least one of the existing gaming components are supplied by different providers such that signals sent therebetween would be unusable absent said capturing, interpreting, and re-presenting of said signals.
